(19) United States
(12) Patent Application Publication
(10) Pub. No.: US 2026/0078545 A1
(43) Pub. Date: Mar. 19, 2026

(54) IMPROVED METHOD FOR A PRINTING PROCESS OF FABRICS

(71) Applicant: ELECTRONICS FOR IMAGING, INC., LONDONDERRY, NH (US)

(72) Inventors: PAOLO MARIA CRIPPA, Bergamo (IT); Giorgio SALA, Bellusco (IT); Andrea FACHERIS, Mozzo Bergamo (IT)

(21) Appl. No.: 19/117,328

(22) PCT Filed: Oct. 16, 2023
(86) PCT No.: PCT/US2023/035240

§ 371 Date: Mar. 31, 2025

(30) Foreign Application Priority Data
Oct. 18, 2022 (IT) 102022000021420

(51) Int. Cl. D06P 1/38; D06P 5/20

(52) U.S. Cl. CPC D06P 1/38; D06P 5/2077

(57) ABSTRACT

An improved method for a digital printing process of fabrics with reactive dye and acid, characterized by comprising a sequence of operating steps defined by a first step comprising a sequence of operations defined by a preparation of the fabric that uses a chemical bath not containing urea, a printing of the fabric and a subsequent drying of the printed fabric, a second step comprising an operation for fixation of the dye transferred with the printing of the first step and a third washing step, the first step prepared on a single machine composed of a digital printing machine.

### CROSS-REFERENCE TO RELATED APPLICATIONS

This application claims priority to Italian patent application 102022000021420, filed Oct. 18, 2022, which application is incorporated by reference herein in its entirety by this reference thereto.

### FIELD

Various of the disclosed embodiments concern an improved method for a printing process of fabrics.

### BACKGROUND

As known, digital printing consists of a printing system based substantially on sending digital files from a personal computer or similar device to a printer which, by means of inkjet or laser printing systems or ultraviolet rays (UV printing) or other known techniques, reproduces the content of the specific file on the fabric.

A fabric for digital printing must be prepared for printing to eliminate any impurities in the fabric that could compromise good printing quality and, consequently, the quality of the finished product.

Preparation of the fabric prior to digital printing thereof has the function of allowing fixation of the dyeing ink to the fabric, avoiding the diffusion or spread of the ink on the fabric and, therefore, improving the printing definition, favoring absorption of the ink on the fabric and, consequently, simplifying drying of the same and also favoring penetration of the dye into the fabric.

Typically, prior to digital printing, a fabric is prepared using a chemical bath containing urea; this is a hygroscopic and hydrotropic substance which, in the case of digital printing, allows diffusion of the dye and, during steaming, favors condensation of the steam on the fabric surface, inhibiting the temperature increase of the same and consequently optimizing the humidity of the fabric to values that correspond to maximum swelling of the fibers.

The fabric treated in the chemical bath with urea must subsequently undergo a drying step at temperatures generally not exceeding 110° C. so as not to cause stiffening (or “binding”) of the fabric due to decomposition of the urea, which is subsequently eliminated by washing, and so as not to cause a loss of urea and a possible and consequent reduction of the color rendering of some inks used for the printing.

The chemical bath step of the fabric and the subsequent drying must be carried out in a stenter machine which is an oven used in the textile industry for drying and heat treating fabric after wet processing. The fabric thus prepared is then stored in a warehouse while awaiting printing with reactive dye and acid on the digital printing machine.

The aspects described above define drawbacks connected with the traditional method for preparation of a fabric for digital printing.

The above drawbacks result in further drawbacks in terms of increased production times and relative costs, in addition to an increase in warehouse storage costs of the fabrics which have been treated in the chemical bath with urea and subsequently dried.

A further drawback is that the fabric treated with urea cannot be stored for a long time and subjected to the light and to temperature variations due to problems with decay of the urea. This can create complications and/or difficulties in terms of management of the production cycles.

A further drawback is represented by the fact that all the products used in the chemical bath for preparation of the fabric must be eliminated by washing the fabric at the end of the printing process and this procedure for elimination of the chemical bath residues entails considerable disposal costs in addition to the time required for the washing operations and consequent environmental problems, such as pollution and the like.

A further drawback is represented by the fact that, after treatment in the chemical bath and prior to printing, the fabric must be dried and this requires adequate space in the plant layout and, furthermore, also entails expenditure in terms of energy consumption.

A known solution for digital printing and for finishing of fabrics comprises a preparatory step prior to digital printing and includes a fabric preparation station arranged between a fabric feed station and a printing station, with said preparation station comprising a tank containing an aqueous solution in which the fabric is immersed, and squeezer rollers designed to squeeze the fabric coming out of the tank to eliminate the excess aqueous solution. However, this solution has the drawbacks described above and a further drawback connected with the dimensions of the printing plant and layout thereof.

It would be advantageous to remedy the drawbacks described above.

### SUMMARY

Embodiments of the invention provide an improved method for a printing process of fabrics.

More specifically, embodiments of the invention provide a method for printing fabrics obtained by digital printing technology with reactive dye and acid.

More specifically, embodiments of the invention provide an improved method for a printing process of fabrics that does not require preparation of the fabrics for printing on specific machines prior to the printing process carried out on a printing machine, with consequent reduction in the correlated costs.

Further, embodiments of the invention provide an improved method for a printing process of fabrics that does not require warehouse storage of the fabrics prepared prior to the printing thereof, with consequent limitation, if not elimination, of the correlated costs.

Further, embodiments of the invention provide a method that does not require urea, and therefore avoids the problems connected with drying the impregnated fabric prior to digital printing, thus reducing energy consumption and correlated costs.

Further, embodiments of the invention provide a method that reduces the cost of disposal of the fabric washing residues after printing and therefore reduces the environmental impact.

Further, embodiments of the invention make available to users an improved method for the digital printing of fabrics such that it can be easily implemented and is economically advantageous.

According to the invention an improved method is provided for a printing process of fabrics, more specifically for the digital printing of fabrics, comprising a sequence of main operating steps defined by a first step, a second step and a third step, with the first step being prepared on a single machine that comprises a digital printing machine.

### BRIEF DESCRIPTION OF THE DRAWINGS

FIG. 1 illustrates a block diagram of an improved method for a digital printing process of fabrics according to the invention.

### DETAILED DESCRIPTION

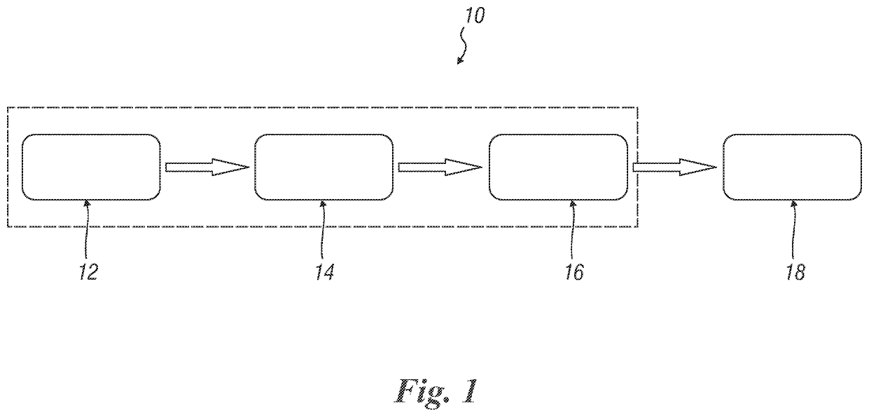

The construction and functional characteristics of the improved method for a printing process of fabrics of the invention will be better understood from the following detailed description in which reference is made to the attached figure that illustrates an embodiment provided only by way of non-limiting example and in which FIG. 1 illustrates a block diagram of the improved method for a digital printing process of fabrics of the invention.

With reference to FIG. 1, the improved method for the digital printing of fabrics of the invention, indicated overall by the number 10, comprises three main steps defined by a first step 12, a second step 14, and a third step 16 which are followed by a step of discharge and/or storage 18 of the fabric subjected to the method of the invention.

The first step 12 comprises a sequence of operations defined by a preparation of the fabric, a printing of the fabric, and a subsequent drying of the printed fabric, all carried out on the same machine.

The second step 14 comprises fixation of the color on the fabric processed (prepared and printed) in the first step 12.

The third step 16 comprises washing of the fabric coming from the second step and drying of the same.

Preparation of the fabric according to the first step 12 is carried out on the digital printing machine, does not use a chemical bath containing urea and comprises an operation of “wetting” the fabric that consists in blade coating of the fabric entering the printing machine with products in aqueous solution that comprise anti-migration and anti-reducing agents and water. The blade coating is carried out in a fabric preparation section arranged between the entry section of the printing machine and the printing unit of said printing machine.

The blade coating of the fabric is carried out by means of application devices such as a doctor blade, screen printing tile frame or roll, or with other devices suitable for the purpose.

Optionally, the first step 12 can comprise a pre-drying carried out after the wetting operation and preferably implemented by means of a blade blower.

The fabric preparation operation is followed by a digital printing operation and subsequent drying of the printed fabric.

The fabric preparation operation (with any optional pre-drying), the printing, and the drying are all carried out on the same machine, namely the printing machine. The fabric coming from a reel is fed onto a conveyor belt of the printing machine and advanced in the direction of a preparation section of the fabric arranged between the entry section of the printing machine and the printing machine itself. In the fabric preparation section the fabric is wetted as previously described.

The fabric is advanced in the preparation section with wetting at a variable speed according to the printing speed.

After the operations in the first step 12 the fabric passes to the second step 14 during which it undergoes an operation for fixing the color transferred with the printing. The fixation operation is carried out with treatment in a steam chamber of a fixation device.

The third step 16 comprises washing of the fabric exiting the printing machine and subsequent drying. The washing is functional to remove the substances in aqueous solution used for the treatment of the fabric during the first step 12.

Once the printed fabric has been dried in the third step 16, it is ready for storage and/or for the preparation of further operations thereon and, for example, can be wound in reels which are then stored for any subsequent operations or for transport and the like.

As can be seen from the above, the advantages offered by the improved method for the printing of fabrics of the present invention are evident.

The improved method for the printing of fabrics of the invention comprises a fabric preparation step, prior to the printing thereof, which is carried out on the same digital printing machine and not on a different dedicated machine as in the traditional methods, and this results in a saving in terms of machine setup, limitation of dimensions and optimized management of plant layout, energy saving and correlated economic saving.

A further advantage is the fact that the method of the invention does not require warehouse storage of the fabric that has undergone the preparation step prior to the digital printing step and this results in limitation, if not elimination, of the costs.

A further advantage is the fact that the method of the invention does not require the use of urea during the step of preparation of the fabric prior to digital printing thereof and this avoids problems connected with drying of the impregnated fabric prior to digital printing and, therefore, problems of plant layout management, increased warehouse costs and energy consumption.

A further advantage is represented by the fact that the method of the invention reduces the disposal costs of the fabric washing residues after printing, thereby reducing the environmental impact.

Although the invention has been described above with particular reference to an embodiment thereof provided only by way of non-limiting example, numerous modifications and variations will appear evident to a person skilled in the art in the light of the above description. The present invention therefore embraces all the modifications and variations that fall within the scope of the following claims.

1. A method for a digital printing process of fabrics with reactive dye and acid, comprising:
a sequence of operating steps, comprising:
a first step comprising a sequence of operations defined by a preparation of the fabric that uses a chemical bath comprising an aqueous solution of anti-migration and anti-reducing agents and water and that does not contain urea, a printing of the fabric, and a subsequent drying of the printed fabric, wherein the first step is performed on a single machine composed of a digital printing machine;
a second step comprising an operation for fixation of the dye transferred with the printing of the first step; and
a third step comprising washing of the fabric exiting the printing machine and subsequent drying.

2. The method according to claim 1, wherein preparation of the fabric comprises a blade coating operation during feed of same fabric to the printing machine.

3. The method according to claim 2, wherein the blade coating operation of the fabric is carried out with products in aqueous solution which comprise anti-migration and anti-reducing agents and water.

4. The method according to claim 3, wherein the blade coating of the fabric comprises application of a doctor blade, screen printing tile frame, or roll type device.

5. The method according claim 3, wherein blade coating is carried out in a section for preparation of the fabric arranged between an entry section of the printing machine and a printing unit of the same printing machine.

6. The method according to claim 5, wherein the fabric is advanced in the preparation section at a speed that is variable and as a function of the print speed.

7. The method according to claim 2, wherein the preparation of the fabric comprises a pre-drying operation subsequent to the blade coating operation and preferably implemented by means of a blade blower.

8. The method according to claim 1, wherein the second step comprises an operation for fixation of the dye transferred with printing, implemented with a treatment in a steam chamber of a fixation device.

9. The method according to claim 1, wherein the third step comprises an operation for washing the fabric exiting from the fixation machine and subsequent drying.
